(19) United States
(12) Patent Application Publication
(10) Pub. No.: US 2010/0295735 A1
(43) Pub. Date: Nov. 25, 2010

(54) Broadband Antenna

(75) Inventors: Kuo-Chan Fu, Taipei County (TW); Tsung-Wen Chiu, Taipei County (TW); Fu-Ren Hsiao, Taipei County (TW); Wen-His Lee, Taipei County (TW)

Correspondence Address: SCHMEISER OLSEN & WATTS, 18 E UNIVERSITY DRIVE, SUITE # 101, MESA, AZ, 85201, US

(73) Assignee: ADVANCED CONNECTEK INC., Taipei County (TW)

(21) Appl. No.: 12/559,354

(22) Filed: Sep. 14, 2009

(30) Foreign Application Priority Data
May 22, 2009 (TW) 098117029

(51) Int. Cl. H01Q 1/36; H01Q 1/48

(52) U.S. Cl. 343/700 MS; 343/848

(57) ABSTRACT

The present invention discloses a broadband antenna, which comprises a radiation conductor, a grounding plane and a feeder cable. The radiation conductor has an inverse V shape. The radiation conductor has an elbow portion; a first leg and a second leg respectively extend from the elbow portion toward two different directions. A terminal of the second leg connects with the grounding plane. The feeder cable has a central wire and an external wire. The central wire connects with the second leg. The external wire connects with the grounding plane. The present invention is characterized in that only a single inverse V-shaped radiation conductor is enough to generate a baseband resonant mode and a frequency multiplication resonant mode for the antenna system, and that the present invention has a simple structure and needn't use a short-circuit member.

### FIELD OF THE INVENTION

The present invention relates to a broadband antenna, particularly to an antenna structure, which can use a single radiation conductor to generate the operational frequency bands of a broadband antenna.

### DESCRIPTION OF THE RELATED ART

A wireless communication device outputs power of RF signals through a feeder cable to the antenna, and the antenna transmits the power of RF signals in form of electromagnetic waves. At a receiving position, a receiving antenna receives the RF signals and sends the RF signals through a feeder cable to a wireless communication product. Therefore, antennae are important media for transmitting and receiving electromagnetic waves. For a transmitting antenna or a receiving antenna, the operational frequency range thereof (the bandwidth) is usually limited to within a specified range. There are two definitions of the bandwidth of the frequency band: one is the bandwidth of the operational frequency band having SWR (Standing Wave Ratio) less than or equal to 1.5; the other is the bandwidth of the operation frequency band having antenna gain within minus 3 dB.

Refer to FIG. 1 a perspective top view of a U.S. Pat. No. 7,505,004. The prior-art patent disclosed a “Broadband Antenna” comprising a radiation member 11, a grounding member 13 and a printed circuit board 15. The radiation member 11 has a first metal plane 111, a second metal plane 112 and a third metal plane 113, which substantially have a rectangular shape, wherein the first metal plane 111 connects with the second metal plane 112, and the second metal plane 112 connects with the third metal plane 113, whereby is formed a U-shape structure. The first metal plane 111 and the third metal plane 113 are parallel to the plane where the grounding member 13 and the printed circuit board 15 are arranged, and the second metal plane 112 is vertical to the plane where the grounding member 13 and the printed circuit board 15 are arranged, whereby the opening of the U-shape structure faces the direction parallel to the grounding member 13 and the printed circuit board 15. The prior-art patent emphasizes that the broadband antenna 100 not only features dual frequency bands but also has better bandwidths.

However, the radiation member 11 of the prior-art patent has a complicated structure. Further, the prior-art patent also needs a connection member 12 having a first end 121 and a second end 122 respectively connected to the radiation member 11 and the grounding member 13 for signal transmission. Furthermore, the radiation member 11 and the connection member 12 respectively have multiple curves, which cause signal attenuation and lower energy transmission efficiency. Besides, the serpentine structures increase the difficulty and cost of fabrication.

### SUMMARY OF THE INVENTION

The primary objective of the present invention is to provide a broadband antenna, wherein only a single inverse V-shaped radiation conductor is sufficient to generate a baseband resonant mode and a frequency multiplication resonant mode, whereby is shortened the path of transmitting radiation signals and promoted the efficiency of transmitting radiation signals and radiation energy.

Another objective of the present invention is to provide a broadband antenna, wherein a first leg and a second leg respectively have straight laterals and extend from an elbow portion of the radiation conductor, whereby the antenna can be exempted from a short-circuit member, and whereby the antenna structure is simplified, and whereby the radiation members needn't be over-bent and over-fabricated, wherefore the assembly process is shortened and the yield is promoted.

A further objective of the present invention is to provide a broadband antenna, wherein the frequency ratio of the baseband mode and the frequency multiplication mode can be adjusted via varying the included angle of the elbow portion and/or varying the position where the central wire connects with the second leg, and wherein the second leg has a terminal connecting with the grounding plane, and wherein the impedance matching of the antenna system can be adjusted via fine tuning the thickness and length of the terminal of the second leg.

To achieve the abovementioned objectives, the present invention proposes a broadband antenna, which comprises a radiation conductor, a grounding plane and a feeder cable. The radiation conductor has an inverse V shape. The inverse V-shaped radiation conductor has an elbow portion; a first leg and a second leg respectively extend from the elbow portion toward two different directions. As the first leg and the second leg respectively have straight laterals, the elbow portion has an included angle. A terminal of the second leg connects with the grounding plane.

The feeder cable has a central wire and an external wire. The central wire connects with a feeder member of the second leg. The external wire connects with the grounding plane.

The embodiments of the present invention are characterized in that only a single inverse V-shaped radiation conductor is enough to generate two resonant modes—a baseband resonant mode and a frequency multiplication resonant mode both jointly forming the operational frequency bands of the broadband antenna. The inverse V-shaped radiation conductor can shorten the path of transmitting radiation signals and promote the efficiency of transmitting radiation energy and radiation signals. As the first leg and second leg of the elbow portion respectively have straight laterals, the broadband antenna is exempted from a short-circuit member. Therefore, the present invention has a simple structure, and the radiation members needn't be over-bent and over-fabricated. Thus, the assembly process is shortened, and the yield is promoted. The frequency ratio of the baseband mode and the frequency multiplication mode can be adjusted via varying the included angle of the elbow portion and/or varying the position where the central wire connects with a feeder member of the second leg. Varying the thickness and length of the terminal of the second leg can modify the imaginary-part impedance of the antenna system and move the ranges of the operational frequencies of the baseband resonant mode and frequency multiplication resonant mode to the frequency bands required by the system, whereby the two resonant modes can have fine impedance matching, and the operational bandwidths are increased.

Below, the embodiments are described in detail to make easily understood technical contents of the present invention.

### BRIEF DESCRIPTION OF THE DRAWINGS

FIG. 1 is a perspective top view of a prior-art broadband antenna disclosed in a U.S. Pat. No. 7,505,004;

FIG. 2 is a perspective top view of a first embodiment according to the present invention;

FIG. 3 is a perspective top view of a second embodiment according to the present invention;

FIG. 4 is a perspective top view of a third embodiment according to the present invention;

FIG. 5 is a diagram showing VSWR measurement results of a broadband antenna according to the present invention; and

FIG. 6 is a partially-enlarged perspective top view showing that the broadband antenna of the present invention is applied to a portable computer.

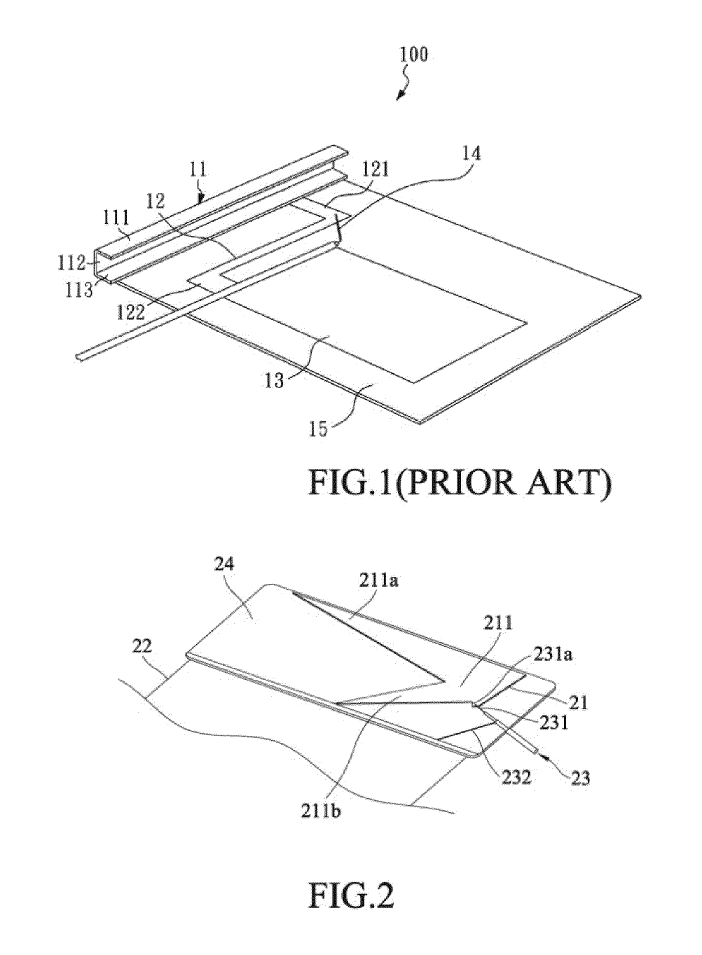

### DETAILED DESCRIPTION OF THE INVENTION

Refer to FIG. 2 a perspective top view of a first embodiment according to the present invention. The broadband antenna of the present invention comprises a radiation conductor 21, a grounding plane 22 and a feeder cable 23. The radiation conductor 21 has an elbow portion 211; a first leg 211a and a second leg 211b respectively extend from the elbow portion 211 toward two different directions. The feeder cable 23 has a central wire 231 and an external wire 232.

The radiation conductor 21 is arranged on a baseplate 24. In the first embodiment, the radiation conductor 21 has an inverse V shape, and the first leg 211a and the second leg 221b of the radiation conductor 21 respectively extend from the elbow portion 211 toward two different directions. As the first leg 211a and the second leg 211b respectively have straight laterals, an angle is included therebetween. The included angle ranges from 15 to 90 degrees. The baseband mode and the frequency multiplication mode can have a better frequency ratio via adjusting the degrees of the included angle. The central wire 231 of the feeder cable 23 connects with the feeder member 231a of the second leg 211b. The external wire 232 connects with the grounding plane 22. The central wire 231 transmits the high frequency signals of the feeder cable 23 to the second leg 211b. The baseband mode and the frequency multiplication mode can have a superior frequency ratio via adjusting the position where the central wire 231 connects with the feeder member 231a of the second leg 211b. The terminal of the second leg 211b connects with the grounding plane 22. Varying the thickness and length of the terminal of the second leg 211b can modify the imaginary-part impedance of the antenna system and move the ranges of the operational frequencies of the baseband resonant mode and the frequency multiplication resonant mode to the frequency bands required by the system.

In the first embodiment, the radiation conductor 21 has an inverse V shape and may be divided into an upper triangle of the first leg 211a and a lower triangle of the second leg 211b. The top and longest side of the upper triangle of the first leg 211a has a length of about 25 mm. The opposite side of the top and longest side has a length of about 23 mm. The base of the upper triangle has a length of about 3.5 mm. The lower side of the lower triangle of the second leg 211b has a length of about 14 mm.

The opposite side of the lower side has a length of about 10.5 mm. The base of the lower triangle has a length of about 3 mm. The baseplate 24 has a shape of a rectangle with a length of about 38 mm and a width of about 7 mm.

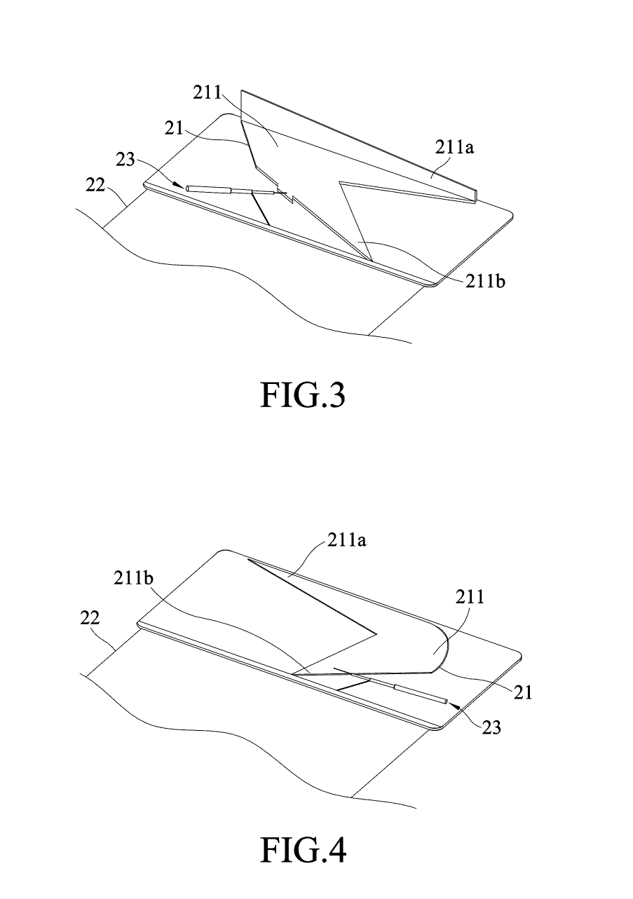

Refer to FIG. 3 a perspective top view of a second embodiment according to the present invention. The second embodiment is different the first embodiment in that the elbow portion 211 and the first leg 211a of the radiation conductor 21 extend upward vertically to expand the transmission area of the radiation conductor 21 and increase the radiation conduction efficiency of the antenna system. As the radiation conductor 21 has a tilted inverse V-shaped pattern, the same principle of configuration can be used to increase the transmission area of the radiation conductor 21.

Refer to FIG. 4 a perspective top view of a third embodiment according to the present invention. The third embodiment is different the first embodiment in that the elbow portion 211 is fabricated to have an arc-like contour to make the outline of the radiation conductor 21 expand from the outside to the inside. The third embodiment is also different the first embodiment in that the central wire 231 does not connect with the feeder member 231a of the second leg 211b but directly connects to the surface of the second leg 211b. From the three embodiments described above, it is known that the inverse V-shaped radiation conductor 21 of the present invention not only can generate two resonant modes by itself but also can be flexibly configured to match the available space of different products.

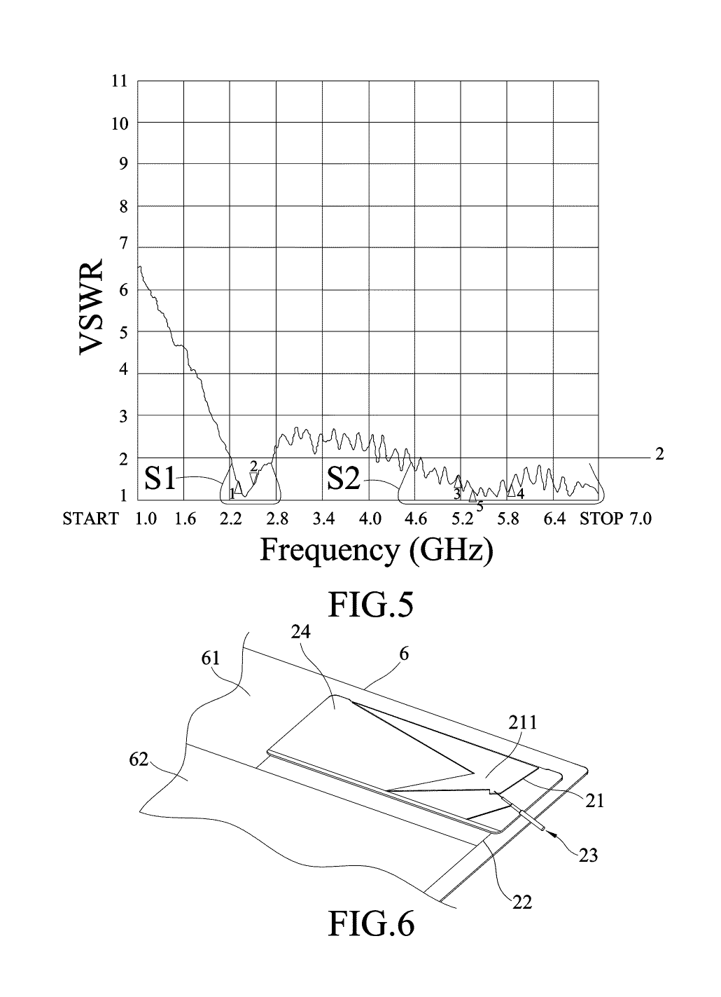

Refer to FIG. 5 a diagram showing the measurement results of the voltage standing wave ratio (VSWR) of a broadband antenna according to the present invention. When operational frequency bands S1 and S2 are defined by a voltage standing wave ratio of 2, the operational frequency band S1 ranges from 2.2 GHz to 2.8 GHz, which covers the frequency bands of the WLAN system (2.4 GHz-2.5 GHz) and the WiMAX system (2.3 GHz-2.7 GHz), and the operational frequency band S2 ranges from 4.6 GHz to 7 GHz, which covers the frequency band of the WLAN system (4.9 GHz-5.9 GHz). The VSWR measurement results prove that the present invention has outperforming operational frequency bands and impedance matching.

Refer to FIG. 6 a partially-enlarged perspective top view showing that the broadband antenna of the present invention is applied to a portable computer. The baseplate 24 below the radiation conductor 21 is attached to the side plate 61 of a portable computer 6. A tin foil is used as the ground plane 22 and stuck to the chassis 62 of the portable computer 6; the chassis 62 functions as the ground plane of the entire antenna system. As the radiation conductor 21 has a tilted inverse V-shaped pattern, the radiation conductor 21 can be deployed to match the available space of a product and convenience the assembly of the product.

The present invention possesses utility, novelty and non-obviousness and meets the conditions for a patent. However, it is to be noted that the embodiments described above are only to exemplify the present invention but not to limit the scope of the present invention. Therefore, any equivalent modification or variation according to the spirit of the present invention is to be also included within the scope of the present invention.

What is claimed is:

1. A broadband antenna comprising
a radiation conductor having an inverse V shape and an elbow portion, wherein a first leg and a second leg extends from said elbow portion;
a grounding plane connecting with a terminal of said second leg; and
a feeder cable having a central wire connecting with said second leg and an external wire connecting with said grounding plane.

2. The broadband antenna according to claim 1, wherein said first leg and said second leg respectively extend toward different directions.

3. The broadband antenna according to claim 1, wherein said elbow portion is fabricated to have an included angle.

4. The broadband antenna according to claim 3, wherein said included angle ranges from 15 to 90 degrees.

5. The broadband antenna according to claim 1, wherein said elbow portion has a shape of a polygon.

6. The broadband antenna according to claim 1, wherein said elbow portion has an arc-like contour.

7. The broadband antenna according to claim 1, wherein said first leg and said second leg respectively have straight laterals.

8. The broadband antenna according to claim 1, wherein said central wire connects with said second leg via a feeder member.
